(19) United States
(12) Patent Application Publication
(10) Pub. No.: US 2012/0040143 A1
(43) Pub. Date: Feb. 16, 2012

(54) ADHESIVE SYSTEM

(76) Inventor: Alfredo Hector Tubert, Buenos Aires (AR)

(21) Appl. No.: 13/013,416

(22) Filed: Jan. 25, 2011

Related U.S. Application Data
(60) Provisional application No. 61/298,344, filed on Jan. 26, 2010.

(51) Int. Cl. C09J 109/00; B32B 3/28; B32B 1/00

(52) U.S. Cl. 428/181; 428/174; 524/502

(57) ABSTRACT

Disclosed is a shapeable layer of a gel adhesive polymer for securing a device to a flat surface, the adhesive gel having a body member defining a first surface for placement adjacent the flat surface and a second non-flat surface for placement against the device, wherein the adhesive gel may be made from thermoplastic rubber, plasticizer oil, and tackifying resin, or a combination thereof. In one embodiment, the second surface of the adhesive gel body member may be corrugated or regular. In another embodiment, the non-flat surface of the device member may be corrugated or regular.

### CROSS REFERENCE TO RELATED APPLICATIONS

This application claims priority to U.S. Provisional Application Ser. No. 61/298,344 filed Jan. 26, 2010, entitled ADHESIVE SYSTEM, the disclosures of which is incorporated herein by this reference in its entirety for all purposes.

### BACKGROUND OF THE INVENTION

The present invention relates generally to adhesives and, more particularly, to a system for securing devices to surfaces.

There are many ways to stick a device to a flat surface like tile walls, mirrors and or glasses. Some ways are permanent, like using construction or multipurpose adhesives, and others are non-permanents, like using suction cups. These non-permanent systems are convenient since the walls are not damaged and the device position or the device itself can be changed easily. But they have limitations like shape, strength and lifetime.

### SUMMARY OF THE INVENTION

Disclosed is a system comprising a device in combination with a shapeable layer of a gel adhesive polymer. According to one aspect of the invention, a system for securing a device to a flat surface comprises: a device having a non-flat surface; an adhesive gel having a body member defining a first surface for placement adjacent the flat surface and a second non-flat surface for placement against the device, wherein the adhesive gel comprises: i) thermoplastic rubber, ii) plasticizer oil, and iii) tackifying resin, or a combination thereof. In one embodiment, the second surface of the adhesive gel body member may be corrugated or regular. In another embodiment, the non-flat surface of the device member may be corrugated or regular.

According to another aspect of the invention, an article of manufacture securing a device to a flat surface comprising an adhesive gel having a body member defining a first surface for placement adjacent the flat surface and a second non-flat surface for placement against the device, wherein the adhesive gel comprises: i) thermoplastic rubber, ii) plasticizer oil, and iii) tackifying resin, or a combination thereof.

### BRIEF DESCRIPTION OF THE DRAWINGS

In the drawings:

FIG. 1 is a side view of an embodiment of the disclosed system illustrating a device with a shapeable layer of a gel adhesive polymer secured thereto relative to a surface.

### DETAILED DESCRIPTION

Disclosed is a new type of system that allows attaching different kind of devices to a flat surface with non-permanent fixation and has many advantages on any other previous system. The disclosed adhesive system permits any shape, is completely clear, and is colorable. These properties allow the creation of new designs, integrating the adhesive system to the product and avoiding the presence of unnecessary pieces (like suction cups) modifying and disturbing the design. The system permits the designers to create with light and color with less restrictions and has a longer lifetime than any previous system.

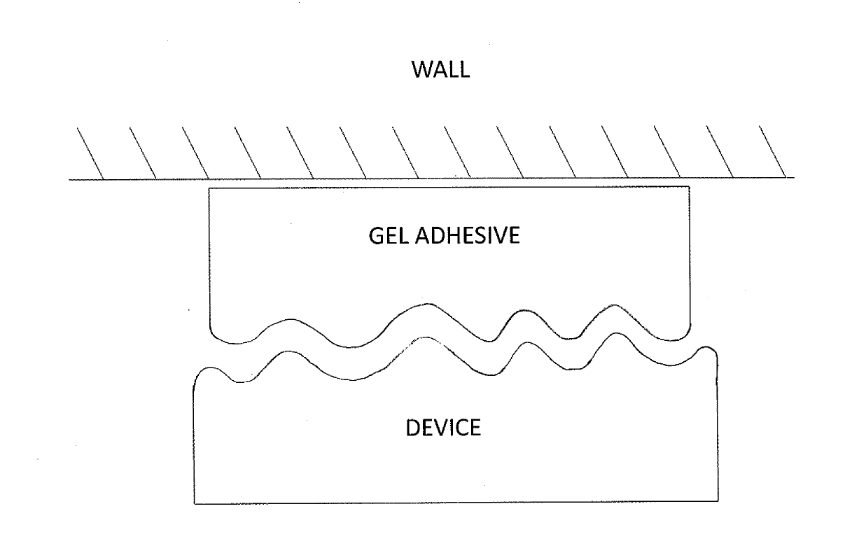

The system is a combination of a device with a shapeable layer of a gel adhesive polymer. The FIG. 1 shows a side schematic of the system. As used herein, the term “wall” refers to any flat surface. This is illustrated in FIG. 1, the surface which forms the juncture of the device and the adhesive gel has a non-flat shape, which, as illustrated, may be corrugated, but may have other non-flat, irregular or regular repeating features.

The gel adhesive provides a non-permanent union between the wall and the device, the strength of which is related to the formulation of the gel adhesive, but may be between 0.1 and 1 pound per square inch of surface bonded.

The gel adhesive can be shaped by injection, open pouring, dye cutting or polymerization to achieve any desired shape. In the disclosed embodiment, the surface of the adhesive gel in contact with the wall is substantially flat. Such surface may have other, non-flat shapes, if the wall is a non-flat shape, or, alternatively, may only partially contact the wall surface in an amount great enough to maintain the strength of the bond there between. Also, the contacting surfaces of the device and the adhesive gel maybe be either flat or non-flat, for example corrugated, along their areas of attachment. In the disclosed embodiment, the surface adjacent the device generally matches the device shape. Note that the surface of the device and the adhesive gel do not need to be exactly complementary in shape, but should have enough contacting surface area to maintain the strength of the bond there between.

The transparency and color of the gel adhesive can be achieved with normal formulations. The nature of the gel adhesive can vary, but in the disclosed embodiments is a polymer. One of the more commons constituent components are the gels based in Thermoplastic Rubber (TPR). Typical formulations of a non-limiting examples of a gel adhesive are as follows:

| Raw material | Minimum (%) | Maximum (%) |
|---|---|---|
| Thermoplastic Rubber (TPR) | 10 | 30 |
| Plasticizer Oil | 10 | 80 |
| Tackifying Resin or Rosin | 0 | 70 |
| Colorant | 0 | 5 |
| Antioxidant | 0 | 1 |

In one embodiment of the formulations listed above, the percentage of Thermoplastic Rubber may be in the range of 5% to 50%, 5% to 45%, 5% to 40%, 5% to 35%, 5% to 30%, 5% to 25%, or 5% to 20%. In yet another embodiment, the of TPR may be the same as above except the lower range value is 10%.

In one embodiment of the formulations listed above, the percentage of Plasticizer Oil may be in the range of 5% to 90%, 5% to 85%, 5% to 80%, 5% to 75%, 5% to 70%, 5% to 65%, 5% to 60%, 5% to 55% or 5% to 50%. In yet another embodiment, the of Plasticizer Oil may be the same as above except the lower range value is 20%.

In one embodiment of the formulations listed above, the percentage of Tackifying Resin or Rosin may be in the range of 0% to 90%, 0% to 85%, 0% to 80%, 0% to 75%, 0% to 70%, 0% to 65%, 0% to 60%, 0% to 55%, 0% to 50%, 0% to 45%, 0% to 40%, 0% to 35%, 0% to 30%, 0% to 25%, 0% to 20%, 0% to 15%, 0% to 10%, or 0% to 5%.

In other embodiments, Polyurethanes or Polyamides may comprise a portion of the adhesive gel.

The possible devices that can be used with the disclosed system are uncountable, for example, not to be limiting, item such as kitchen hooks, stands, soap holders, bath minors, pen and paper holders and many stationery products, cell phone holders , jewelry hooks, key holders, toilette and kitchen paper holders, photo frames, vases for flowers and plants, and many others.

Typical materials from which the devices are made, and to which the gel adhesive will adhere, are plastics such as Acrylic, Polystyrene, ABS, and Polypropylene as well as other materials such as wood, metals, canvas or any other materials or combinations of any of the foregoing that have good adhesion strength to the gel adhesive.

An gel adhesive as disclosed has a lifetime of several years under the common life conditions.

The present invention is illustratively described above in reference to the disclosed embodiments. Various modifications and changes may be made to the disclosed embodiments by persons skilled in the art without departing from the scope of the present invention as defined in the appended claims.

What is claimed is:

1. A system for securing a device to a flat surface comprising:
a device having a non-flat surface;
an adhesive gel having a body member defining a first surface for placement adjacent the flat surface and a second non-flat surface for placement against the device, wherein the adhesive gel comprises:
i) thermoplastic rubber,
ii) plasticizer oil, and
iii) tackifying resin, or
a combination thereof.

2. The system of claim 1 wherein the second surface of the adhesive gel body member is corrugated.

3. The system of claim 1 wherein the non-flat surface of the device member is corrugated.

4. An article of manufacture securing a device to a flat surface comprising an adhesive gel having a body member defining a first surface for placement adjacent the flat surface and a second non-flat surface for placement against the device, wherein the adhesive gel comprises:
i) thermoplastic rubber,
ii) plasticizer oil, and
iii) tackifying resin, or
a combination thereof.

5. A composition of matter comprising in combination thermoplastic rubber, plasticizer oil, and tackifying resin, and colorant.
